(19) United States
(12) Patent Application Publication
(10) Pub. No.: US 2025/0067450 A1
(43) Pub. Date: Feb. 27, 2025

(54) Stacked Evaporator Air Cooler

(71) Applicant: Portacool, LLC, Center, TX (US)

(72) Inventors: Patrick W. Van Deventer, Tyler, TX (US); Matthew J. Rizzo, Cedar Park, TX (US); James L. Allen, Tyler, TX (US)

(73) Assignee: Portacool, LLC, Center, TX (US)

(21) Appl. No.: 18/236,670

(22) Filed: Aug. 22, 2023

(51) Int. Cl. F24F 5/00; F24F 1/0284; F24F 1/037; F24F 1/04; F24F 11/77

(52) U.S. Cl. CPC F24F 5/0035; F24F 1/0284; F24F 1/037; F24F 1/04; F24F 11/77

(57) ABSTRACT

An evaporator air cooler having vertically stackable major components. A water reservoir is located within the bottom panel of the housing. A filtered media is positioned generally above the water reservoir. A fan is positioned above the water reservoir and the filter media. In this manner, the footprint of the unit is minimized. The warm air intake and the cool air discharge are located on the same side of the housing so that the unit may be placed against a wall thereby further minimizing the footprint. Automated controls are included to monitor temperature and humidity than oscillate the vertical louvers.

### FIELD OF THE INVENTION

This invention relates generally to an evaporator air cooler.

### BACKGROUND OF THE INVENTION

Evaporator air coolers are commonly used to cool air in a workshop, patio or another hot, dry air environment. Such coolers typically comprise a fan, an evaporative cooling media, and a water reservoir. Such coolers typically operate by drawing hot or warmer air into the housing of the evaporator air cooler through a water-soaked filter or evaporator media. As the warm air passes through the water-soaked filter or evaporator media, the temperature of the air is lowered and the humidity increases. Frequently, such evaporator air coolers are also portable.

Typically, such portable coolers have the fan and water-soaked filter or evaporator media in series so that air is drawn through one side of the housing of the cooler and discharged through the opposite side. This creates two main problems. First, the overall footprint of the housing is large because of the amount of space needed to fit the fan and the media components in series within the product housing. Second, water droplets from the media can easily become entrained into the fan intake due to the high velocity of the air being suctioned which produces an undesirable blow off of water on the discharge side of the housing and out into the area the cooler being used to cool.

Thus, the need exists for a portable evaporator air cooler which has a smaller footprint than conventional products and also minimizes the amount of water being drawn into the fan and discharged through the air exhaust.

Additionally, the need exists for a portable evaporator air cooler with improved monitoring and control features.

### SUMMARY OF THE INVENTION

The present invention is an improved portable evaporator air cooler comprising a housing, a water reservoir proximate the base of the housing, a water-soaked filter or evaporator media supported above the evaporator media, and a fan supported above the media. In this manner the major components are stacked reducing the footprint. The housing is sealed except for the warm air intake register adjacent one side of the evaporator media and the cool air discharge register for the cool air from the fan. Both the warm air intake register and the cool air discharge register are preferably located on the same side of the housing. This permits the unit to be located against a wall without blocking air intake or air discharge further minimizing the footprint of the unit.

Preferably, the water reservoir is an integral part of the lower portion of the housing and includes a recessed well area. An electric pump is elevated slightly above the well recessed area in order that sediments may collect below the pump intake. The recessed area of the reservoir further aids the integrity of the unit.

The present invention also includes a water spray member mounter atop the media. The electric pump draws water from the reservoir which is then sprayed onto the top of the media filtering down through the media and saturating it. As the housing is sealed except for the warm air intake and the cool air outlet, the fan intake must draw air through the warm air intake register. Since the air intake is sealed against one side of the evaporator media the warm air is cooled as it passes through the evaporator media and the humidity of the air is increased due to the water content in the evaporator media. The cooler air is then sucked into the fan intake and discharged through the fan discharge end which is sealed against the cool air discharge register. Moveable louvers are preferably located within or proximate the cool air discharge register.

The present invention may also include controls to adjust the speed of the fan and the water pump rate for cooling and humidity control and the direction and angular movement of the louvers. The present invention may also include sensors to monitor the water level within the reservoir and turn the pump off if the water level gets below a preselected limit. The present invention may also include monitors to measure the efficiency of the evaporator media for temperature and humidity output. The present invention may also include radio or Wi-Fi capability to monitor the output of the sensors and monitors and to control the operation of the unit remotely with a PC or an App on a smart phone, either via direct communication with an evaporator air cooler control, or by relaying commands and settings through a cloud-based infrastructure.

Accordingly, the present disclosure includes features and advantages which are believed to enable it to advance portable evaporator cooling technology. Characteristics and advantages of the present disclosure described above, and additional features and benefits will be readily apparent to those skilled in the art upon consideration of the following detailed description of various embodiments and referring to the accompanying drawings.

### BRIEF DESCRIPTION OF THE DRAWINGS

The following figures are part of the present specification, included to demonstrate certain aspects of various embodiments of this disclosure and referenced in the detailed description.

FIG. 1 is a frontal perspective view of the present invention.

FIG. 2 is a front view of the present invention.

FIG. 3 is a right-side view of the present invention.

FIG. 4 is a left side view of the present invention.

FIG. 5 is a back view of the present invention.

FIG. 6 is a bottom view of the present invention.

FIG. 7 is a top view of the present invention.

FIG. 8A is a bottom perspective view of the bottom panel of the present invention.

FIG. 8B is a detailed view of the water level system of the present invention.

FIG. 9 is a cross-sectional view of the present invention.

FIG. 10 is a detailed perspective view of the misting system of the present invention.

FIG. 11 is an exploded view of FIG. 10.

FIG. 12 is a cross-sectional view of the misting system of the present invention.

FIG. 13 is an exploded view of the major interior components of the present invention.

FIG. 14 is an assembled view of the components shown in FIG. 13.

FIG. 15 is a perspective of the fan and louver components of the present invention.

FIG. 16 is a top sectional view of the louver components of the present invention.

FIG. 17 is an exploded view of the louver components of the present invention.

FIGS. 18A-18B are compressed perspective views of a portion of the louvered components of the present invention.

FIG. 19 illustrates the control panel of the present invention.

FIG. 20 illustrates the controller of the present invention.

FIG. 21 is a functional block diagram of the control system of the present invention.

### DETAILED DESCRIPTION OF THE PREFERRED EMBODIMENTS

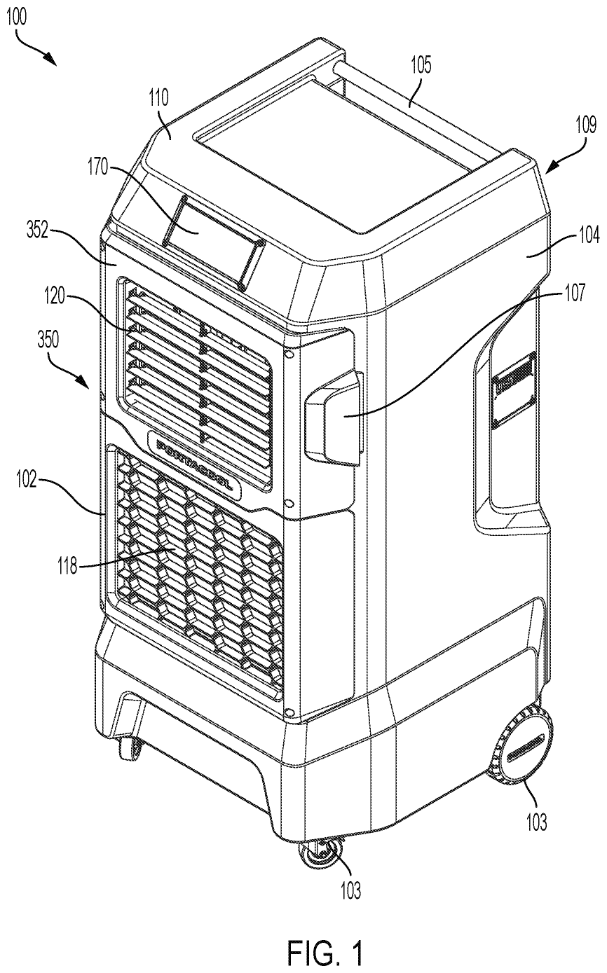

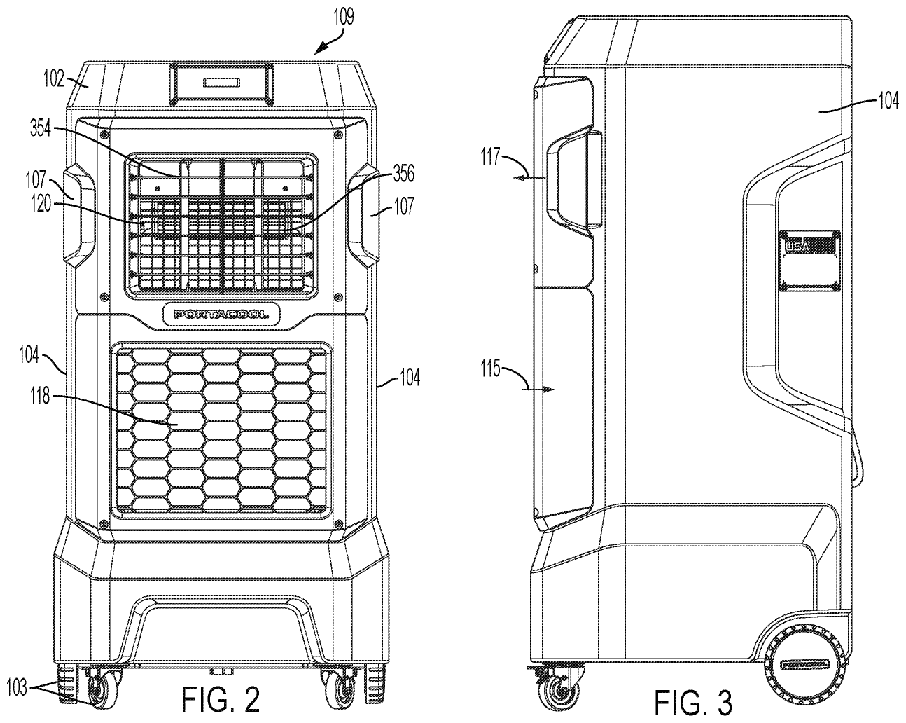

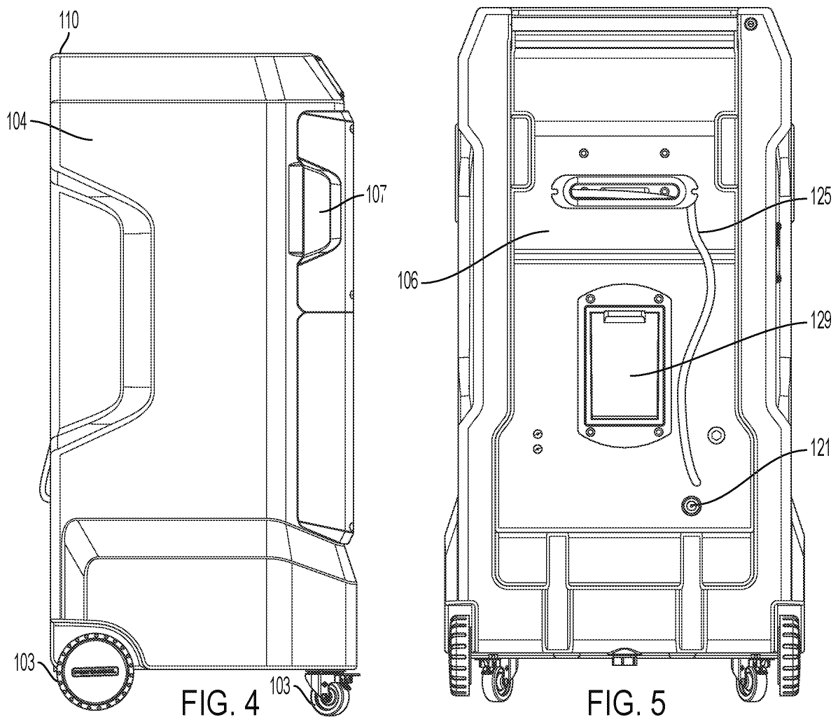

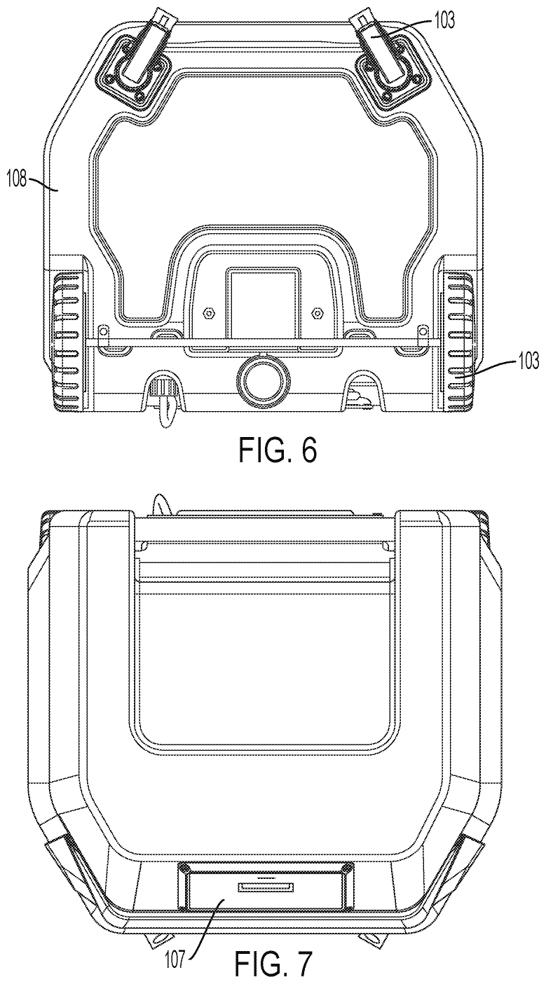

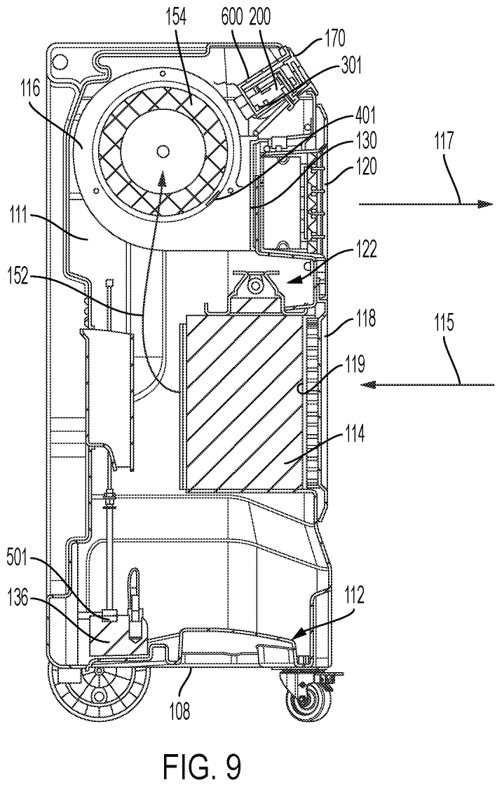

Referring to FIGS. 1-7, the present invention is a portable evaporator air cooler 100 having a front panel 102, side panels 104, back panel 106, bottom panel 108, and top panel 110. Panels 102/104/106/108/110 once assembled define housing 109 having an interior 111. Front panel 102 includes a warm air intake register 118 and a cool air discharge register 120. Preferably, once all the panels are assembled, interior 111 (FIG. 9) is generally air-tight except for air flow as shown by arrows 115 and 117 into and out of interior 111 through the registers 118 and 120. Since the present invention is intended to be portable it includes handles 107 and top bar 105. Wheels 103 may be mounted to bottom panel in order to make cooler 100 more portable. Alternatively, the cooler 100 may not be portable but may be wall mounted above a table or toolbox, for example.

Referring back to FIG. 5, back panel 106 includes a water hose hook-up 121 and a power cord 125, as will be described in more detail below. Back panel 106 may also include an access port 129 which enables the operator to reach inside interior 111 if desirable or to add water or ice through a larger opening. Access port 129 which seal against back panel 106.

Referring now to FIG. 9, the present invention further includes a water reservoir 112 preferably molded within bottom panel 108. A pump 136 transfers water from reservoir 112 to a misting system 122. Misting system 122 drips water onto filter media 114. Positioned above filter media 114 is fan 116. In this manner, the major compliments are stacked. That is, water reservoir 112 is at the bottom, filter media 114 is above reservoir 112, and fan 116 is above the media. In this manner, the footprint of the present invention is minimized. With the operation of fan 116, warm air is drawn into the interior 111 of housing 109 in the direction of arrow 115. The warm air passes through media 114 and is cooled. The cooled air then is drawn into the fan 116 intake 154 and discharged through the cool air registers 120. The operation and major compliments of the present invention will now be described in more detail.

### Water Reservoir

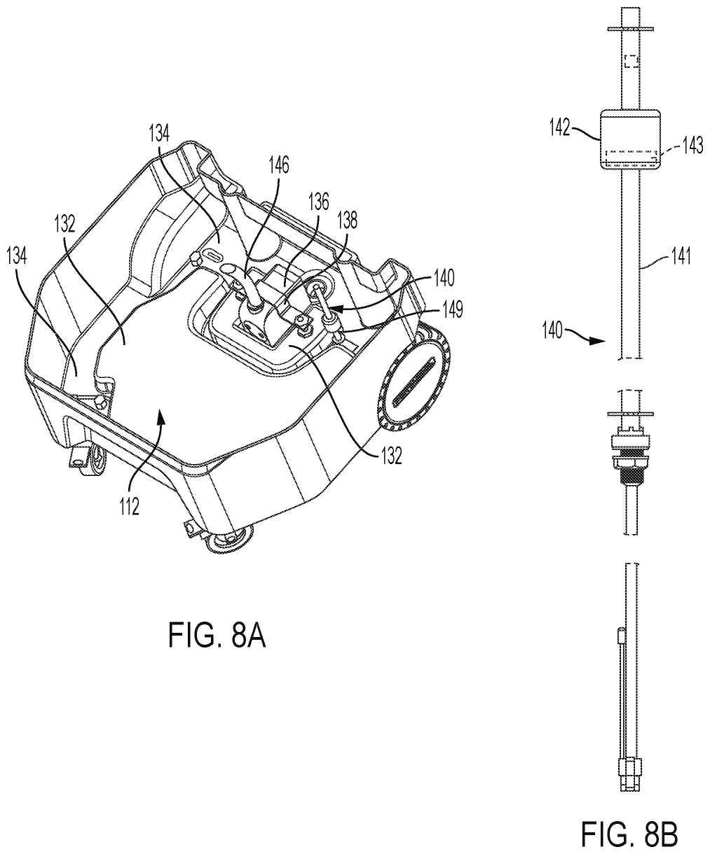

Referring to FIG. 8A, water reservoir 112 is located within bottom panel 108. Water reservoir 112 is preferably an integral part of panel 108. Panel 108 is preferably molded with raised portions 132 to provide additional strength and rigidity to housing 109. Raised portions 132 also define recessed regions 134 surrounding raised portions 132. Water is stored within panel 108 with the top level being preferably above raised portions 132. In this manner, sediments remaining after water is pumped as described below will remain in recessed regions 134. Pump 136 is preferably mounted on top of a raised portion 132 so that it is elevated above the bottom of recessed regions 134. Is this manner, as sediment is collected in recessed regions 134 it will not be suctioned into pump 136 and damage it. Pump 136 is a water pump available for example from Franklin Electric of Fort Wayne, Indiana as model PES-130. It is electrically powered with power conduit 125 extending out through back panel 106 with a sealed O-ring around the power cord against the back panel 106. Pump 136 is held in place by bracket 138 which is attached to beam portion 132.

Referring now to FIGS. 8A, 8B, and 13, a float cut-off system 140 is preferably mounted in bottom panel 108. Float cut-off system 140 includes a float 142 having a magnet 143 which floats at the water surface on a vertical post 141. As water is pumped, float 142 drops in elevation triggering different digital sensors located on an integrated circuit board on post 141. The movement of the magnet 143 along post 141 triggers a digital output signal which is sent to controller 200 as discussed further below. Sensor 501 is fully potted for submerged applications. For example, a suitable sensor is manufactured by CTS of Boise, Idaho, model number QT06047-014. In this manner, as the water level drops below the intake of pump 136 the power to pump 136 is turned off preventing pump 136 from being damaged. An off-on switch 149 may be included to permit water from a hose attached to nozzle 121 (FIG. 5) to open when the water level reaches a predetermined low level along rod 141 sensed by the magnet 143 and the integrated circuit board on post 141. Similarly, off-on switch 149 would close prohibiting further water from entering water reservoir 112 when the magnet 143 and the integrated circuit board 142 reached a predetermined high level along rod 141.

### Misting System

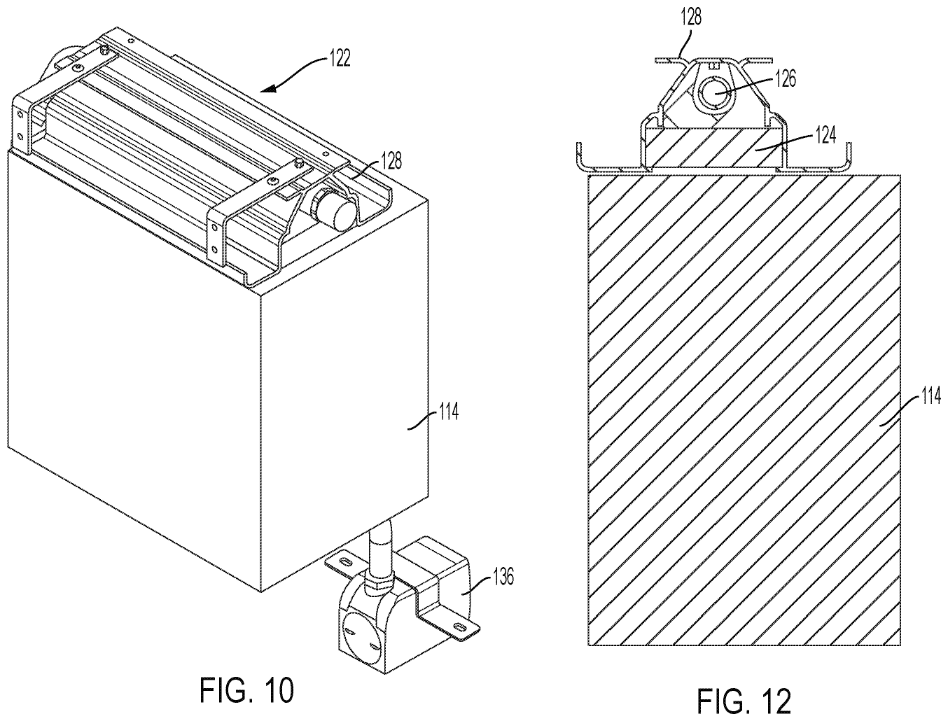

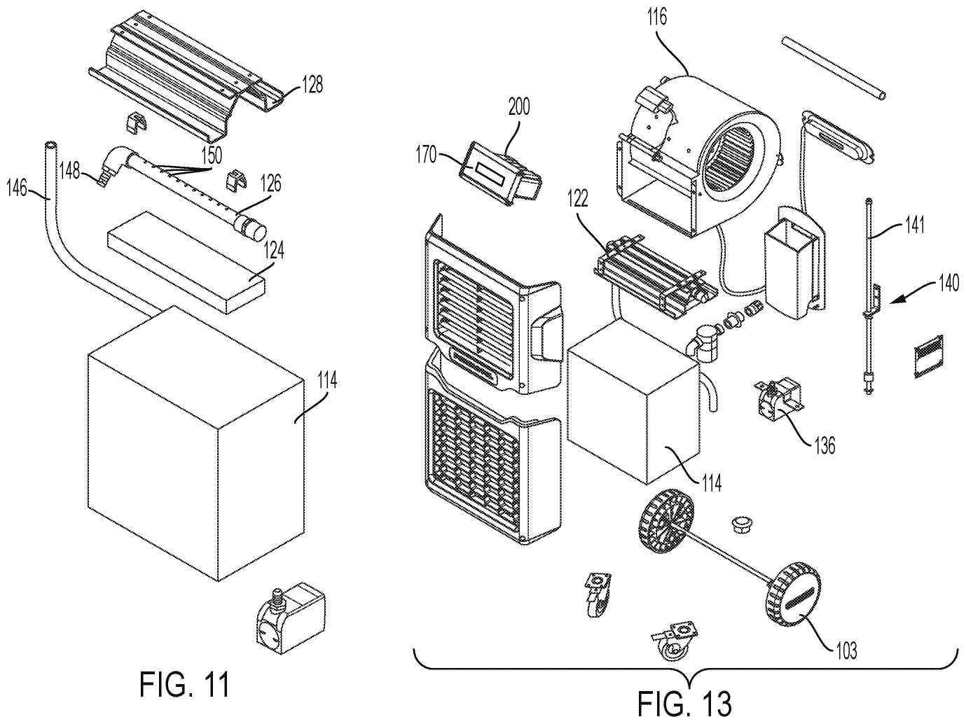

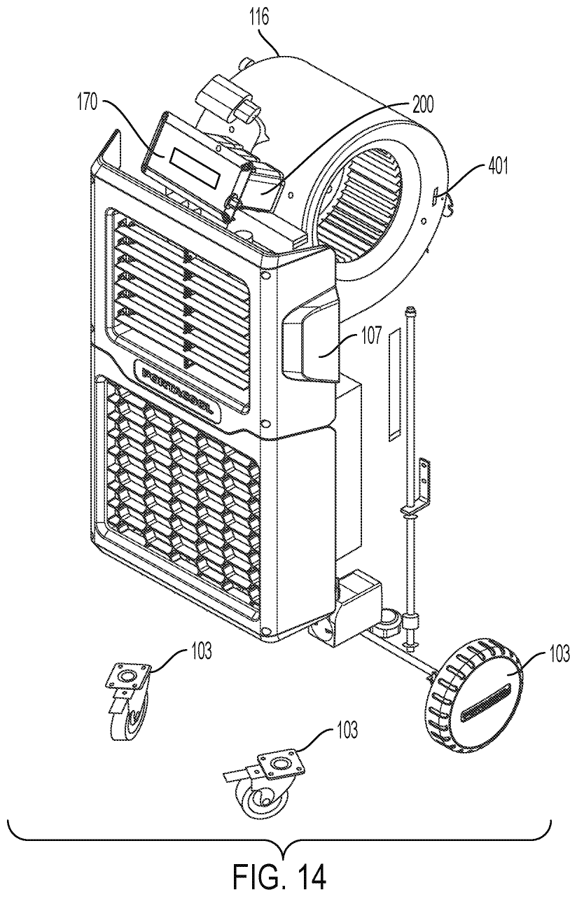

Referring to FIGS. 10-11, a misting system 122 is shown comprising a misting bar 126 supported on a distribution media 124. A bonnet 128 is positioned over misting bar 126. Misting system 122 is supported on top of filter media 114. Media 114 is preferably manufactured rigid cellulose or fiberglass by Port-a-Cool of Center, Texas under the trademark KUUL. Hose 146 extends between the output port of pump 136 and nozzle 148 of misting system 122. Misting bar 126 includes a plurality of apertures 150 along the longitudinal length of misting bar 126. As water exits apertures 150 it drips onto distribution media 124 and then seeps into filter media 114. Bonnet 128 serves to contain the spray of water from the misting bar, preferably limiting its direction toward the distribution media 124. In this manner, as the present invention is operated water droplets are not suctioned off into the fan unnecessarily thereby raising the humidity.

### Fan Operation

Referring back to FIG. 9, the front side 119 of filter media 114 is positioned against warm air intake register 118 is a substantially air-tight manner so that when suction occurs through the operation of fan 116 warm air from outside is generally prohibited from entering interior 111 except through the intake register 118. Similarly, fan exit port 130 is positioned against cool air discharge register 120 in a substantially air-tight manner so that when the fan operates discharged cooler air may only exit through the cool air register 120 in the direction of arrow 117.

Referring still to FIG. 9, since interior 111 is substantially sealed except for the warm air intake register 118 the suction created by fan 116 necessarily moves the warm air through filter media 114. As the warm air moves through filter media 114 it is cooled as a result of the water dripping off misting bar 126 and saturating distribution media 124 and filter media 114. The cooler air passes through media 114 and into intake 154 of fan 116, as shown by arrow 152. Since interior 111 is substantially sealed except for the warm air intake register 118, the only air entering intake 154 of fan 116 is the cooled air coming through filter media 114.

### Louvers System

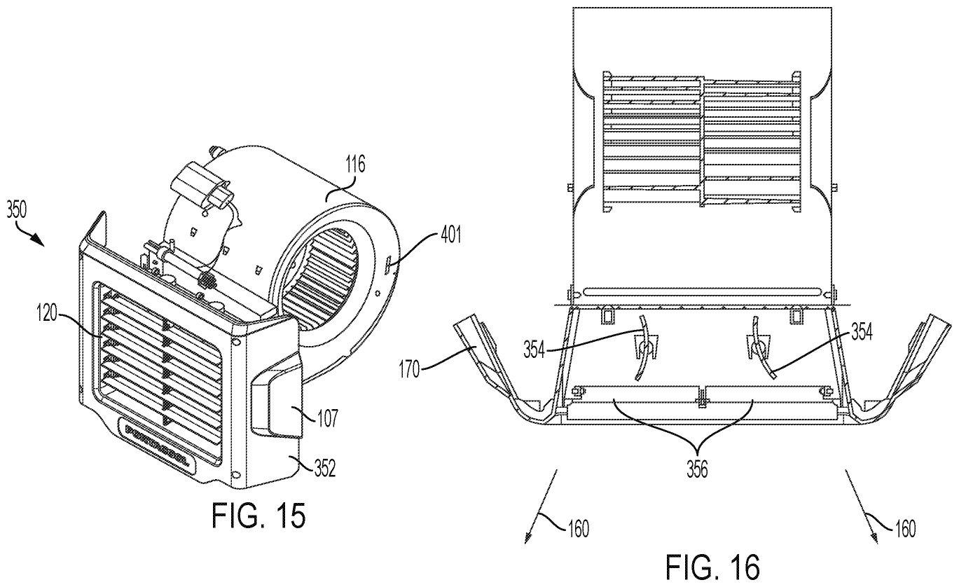

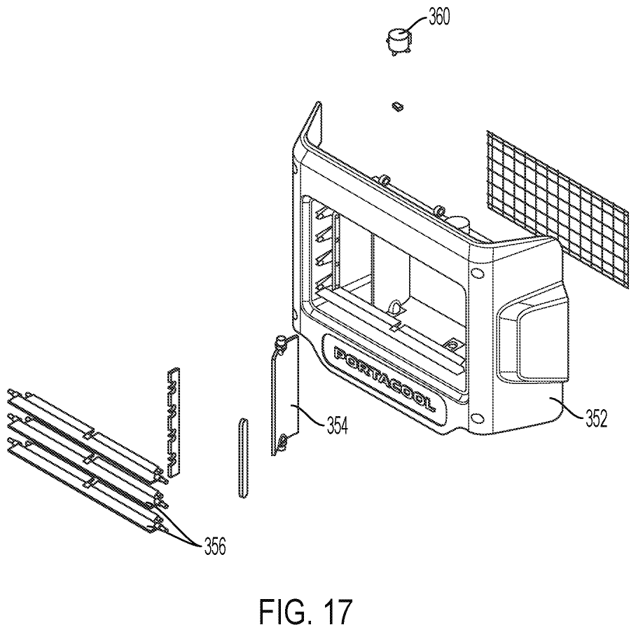

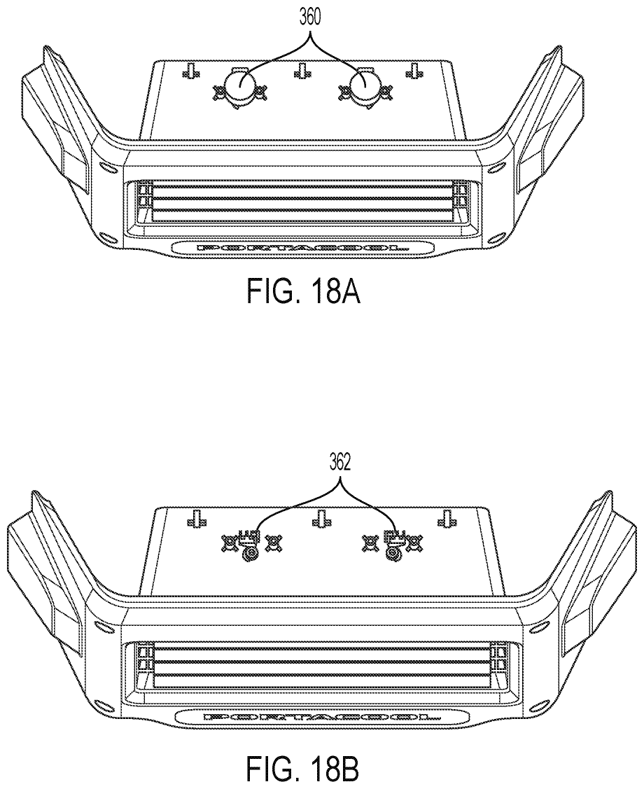

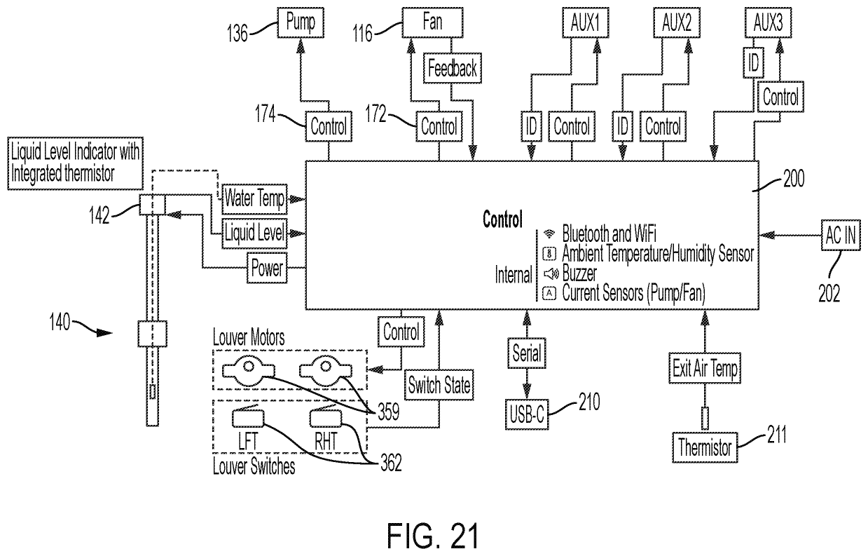

Referring now to FIGS. 1, and 15-18D, louvers system 350 includes an outer housing 352 which fits onto front panel 102 in a sealed manner. Housing 352 supports vertical louvers 354 and horizontal numbers 356. Vertical louvers 354 are preferably curved as shown in FIG. 16 so that cool air exiting fan 116 is deflected horizontally and outwardly towards side panels 104 as shown by arrows 160. Horizontal louvers 356 are substantially parallel to one another and serve to deflect the cooler air vertically. Louvers 354 and 356 are supported at either end of within housing 352. Vertical louvers 356 are rotated along their vertical axis through the use of two stepper motors 359 (FIG. 21) are positioned below each cover 360—one stepper motor for each vertical louver. Stepper motors are well known to convert pulse signals from a controller into motor motion to achieve precise positioning. For example, a stepper motor 360 suitable in this application is manufactured by Changzhou Goot Motor Tech Co., Ltd of Changzhou, China, model number 28BYJ. The range of each stepper motor oscillating a vertical louver 354 is controlled by corresponding limit switches 362. Louver system 350 forms the cool air discharge register 120 at the exhaust and of fan 116. Horizontal louvers 356 are manually adjusted.

### Console Panel

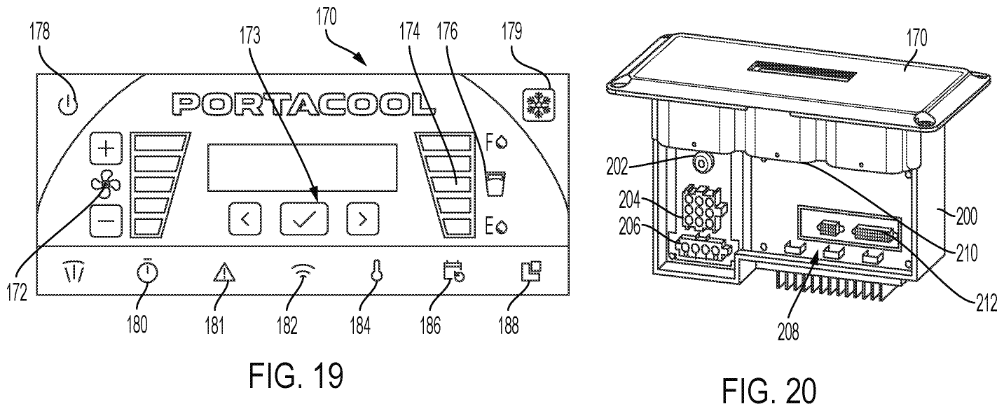

Referring to FIG. 19, a console panel 170 (FIG. 1) is mounted proximate the upper portion of front panel 102. Preferably, console panel 170 includes an LCD display. It would also preferably include a control 172 for the speed of fan motor 116 and a control 174 for the level humidity desirable. It would also preferably include a water level indicator temperature indicator 176, a power switch 178, a pump speed indictor 179, a run timer 180, Wi-Fi connection indicator 182, an alert status 181, mode status indicator 184, schedule status 186, setting status button 188. The console panel would include an icon light bar for illumination.

### Controls

Referring to FIGS. 20-21, controller 200 is mounted preferably on the backside of panel 170 as shown. Controller 200 includes an AC inlet connector 202 a motor connector 204, a pump connector 206, a liquid level indicator connector 208, a USB-C serial connector 210 and stepper motor/switch connectors 212 for the operation of the louvers. Ambient air is permitted to circulate within the enclosed housing supporting the console panel and the controller as shown in FIG. 21 is a functional block diagram for the operation of controller 200 and panel 170 with similar numerals to indicate the same activity mentioned above.

### Sensors

The present invention includes integrated temperature and humidity sensors for sensing temperature and humidity at various locations. There are three principal sensors that accomplish this purpose. Referring to FIG. 9, sensor 301 within enclosure 600 for controller 200 serves to monitor circulation of air around controller 200, sensor 401 which monitors air temperature exiting the fan proximate fan port 119 and passing through cool air discharge register 120, and sensor 501 which monitors the temperature of the liquid within water reservoir 112. With regard to sensor 301, controller 200 is mounted within enclosure 600 on front panel 102. In this manner, the electronics of controller 200 are isolated from the higher humidity of interior 111 and also provide an enclosed space for the reading of ambient temperature outside of the unit. Ambient air may enter enclosure 600 through small air channels (not shown) around control panel 170. The ambient air flows over sensor 301 and exits enclosure 600. For example, a suitable sensor 301 is manufactured by Adafruit Industries LLC of NYC, NY as, model number 385. With regard to sensor 401 it is preferably placed in close proximity to the cool air exiting fan 116. For example, a suitable sensor 401 is manufactured by CTS of Boise, Idaho, model number QT06047-014. With regard to sensor 501, reference is made to FIGS. 8A and 8B above. Temperature sensor 501 may be integrated with the digital sensor monitoring fluid level as discussed above with respect to FIG. 8B. For example, a suitable sensor 501 is manufactured by CTS of Boise, Idaho, model number QT06047-014.

### Operation

In the operation of the present invention water is stored within water reservoir 112. Once pump 136 is turned on water is suctioned out of reservoir 112 and passes through hose 146, nozzle 148 and into misting bar 126. Water then descends from the apertures 150 in the misting bar and then drips through the distribution media 124 into the filter media 114. Fan 116 is then activated which suctions warm air through air intake register 118, drawing it through media 114 and into intake 154 fan 116. The fan then discharges the cooler air through the fan exit port 130 and passes louvers 155 and 156 which deflect the cooler air in the desired position.

Referring to FIGS. 19-21, Sensors 501 monitors the temperature of the liquid within the water reservoir and through connection 208 feeds this information to controller 200. Similarly, sensor 41 which monitors air temperature exiting the fan proximate fan port 119 feeds this information to connector 211 (FIG. 21) of controller 200. Sensor 301 within enclosure 600 monitors ambient air pressure and also feeds this information to controller 200. Once the unit is turned on with the power button on panel 170 as shown in FIG. 10, the operator may adjust the speed of the fan 172 within controller 200. The operator may also adjust the temperature at 174 by increasing or decreasing the amount of water being pumped by pump 136 through media 114. The operation of the unit may be set through a timer status 180. This may also be performed by Wi-Fi 182 through a suitable app on a smartphone. The orientation of vertical louvers 354 may be adjusted by movement of stepper motor 356 using controls 173 on panel 170. Controller 200 also monitors the humidity by sensor 301. In this manner, the operation of the present invention is fully controlled by the operator from panel 170 through controller 200.

Characteristics and advantages of the present disclosure and additional features and benefits will be readily apparent to those skilled in the art upon consideration of the following detailed description of exemplary embodiments of the present disclosure and referring to the accompanying figures. The description herein and appended drawings, being of example embodiments, are not intended to limit the claims of this patent or any patent or patent application claiming priority hereto. On the contrary, the intention is to cover all modifications, equivalents and alternatives falling within the spirit and scope of the claims. Changes may be made to the particular embodiments and details disclosed herein without departing from such spirit and scope.

In showing and describing preferred embodiments in the appended figures, common or similar elements are referenced with like or identical reference numerals or are apparent from the figures and/or the description herein. The figures are not necessarily to scale, and certain features and certain views of the figures may be shown exaggerated in scale or in schematic in the interest of clarity and conciseness. Like numbers refer to like elements throughout.

As used herein and throughout various portions (and headings) of this patent application, the terms “disclosure”, “present disclosure” and variations thereof are not intended to mean every possible embodiment encompassed by this disclosure or any particular claim(s). Thus, the subject matter of each such reference should not be considered as necessary for, or part of, every embodiment hereof or of any particular claim(s) merely because of such reference.

The term “coupled” and the like, and variations thereof, as used herein and in the appended claims are intended to mean either an indirect or direct connection or engagement. Thus, if a first device couples to a second device, that connection may be through a direct connection, or through an indirect connection via other devices and connections.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another.

Certain terms are used herein and in the appended claims to refer to particular components. As one skilled in the art will appreciate, different persons may refer to a component by different names. This document does not intend to distinguish between components that differ in name but not function.

Also, the terms “including,” “having,” and “comprising” are used herein and in the appended claims in an open-ended fashion, and thus should be interpreted to mean “including, but not limited to . . . .” Further, reference herein and in the appended claims to components and aspects in a singular tense does not necessarily limit the present disclosure or appended claims to only one such component or aspect, but should be interpreted generally to mean one or more, as may be suitable and desirable in each particular instance.

Preferred embodiments of the present disclosure thus offer advantages over the prior art and are well adapted to carry out one or more of the objects of this disclosure. However, the present disclosure does not require each of the components and acts described above and are in no way limited to the above-described embodiments or methods of operation. Any one or more of the above components, features and processes may be employed in any suitable configuration without inclusion of other such components, features and processes. Moreover, the present disclosure includes additional features, capabilities, functions, methods, uses and applications that have not been specifically addressed herein but are, or will become, apparent from the description herein, the appended drawings and claims.

The suffix “(s)” as used herein is intended to include both the singular and the plural of the term that it modifies, thereby including at least one of that term (e.g., the colorant(s) includes at least one colorant). “Optional” or “optionally” means that the subsequently described event or circumstance can or cannot occur, and that the description includes instances where the event occurs and instances where it does not. As used herein, “combination” is inclusive of blends, mixtures, alloys, reaction products, and the like.

The present invention now will be described more fully hereinafter with reference to the accompanying drawings, in which some preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Certain terms are used herein and in the appended claims to refer to particular components. As one skilled in the art will appreciate, different persons may refer to a component by different names. This document does not intend to distinguish between components that differ in name but not function.

1. An evaporative air cooler comprising:
a housing having a front panel, side panels, top panel and bottom panel defining an interior of the evaporative air cooler;
a warm air intake register positioned within the front panel;
a cool air discharge register positioned within the front panel;
a water reservoir formed within the bottom panel, said bottom panel having a lower portion and an upper portion;
a filter media position and supported above the water reservoir within the interior of the housing, said filter media having an intake side positioned proximate the warm air intake register and a discharge side;
a water misting system positioned within the interior above the filter media comprising a misting bar;
a pump positioned and support within the upper portion of the water reservoir, said pump having a conduit in fluid communication with water inside the water reservoir and the misting bar; and
a fan positioned within the interior generally above the water misting system, said fan having an intake region generally proximate the discharge end of the filter media and a discharge region proximate the cool air discharge register,
wherein the interior of the evaporative air cooler is substantially sealed except for the warm air intake register and a cool air discharge register.

2. The evaporator air cooler of claim 1 further comprising:
a controller to control the speed of the fan and the amount of water being pumped by said pump; and
sensors to monitor the level of water in the water reservoir, the ambient air temperature outside the housing, and the air temperature being discharged by the fan.

3. The evaporator air cooler of claim 2 further comprising sensor to monitor the humidity of the cool air being discharged.

4. The evaporator air cooler of claim 2 wherein said controller further controls the amount of water being suctioned by the pump from the water reservoir.

5. The evaporator air cooler of claim 1 wherein,
said cool air discharge register comprises:
at least one vertical and horizontal louver; and
at least one motor to oscillate the at least one vertical louver about its vertical access.

6. The evaporator air cooler of claim 4 wherein
said controller controls the oscillation of the at least one vertical louver.

7. The evaporator air cooler of claim 4 wherein the at least one vertical louver comprises a curved horizontal profile.

8. The evaporator air cooler of claim 1 further comprising a sensor to monitor when the level of water in the water reservoir is below or above predetermined values.

9. The evaporator air cooler of claim 1 further comprising wheels mounted to the bottom panel.

10. An evaporative air cooler comprising:
a housing having a front panel, side panels, top panel and bottom panel defining an interior of the evaporative air cooler;
a warm air intake register positioned within the front panel;
a cool air discharge register positioned within the front panel;
a water reservoir formed within the bottom panel, said bottom panel having a lower portion and an upper portion;
a filter media position and supported above the water reservoir, said filter media having an intake side positioned proximate the warm air intake register and a discharge side;
a water misting system positioned above the filter media comprising a misting bar;
a pump positioned and support within the upper portion of the water reservoir, said pump having a conduit in fluid communication with water inside the water reservoir and the misting bar;
a fan generally positioned above the water misting system, said fan having an intake region generally proximate the discharge end of the filter media and a discharge region proximate the cool air discharge register;
a controller to control the speed of the fan and the amount of water being suctioned by said pump;
sensors to monitor the level of water in the water reservoir, the ambient air temperature outside the housing and the air temperature and humidity being discharged by the fan; and
said cool air discharge register comprises at least one vertical and horizontal louver and at least one motor to oscillate the at least one vertical louver about its vertical access,
wherein the interior of the evaporative air cooler is substantially sealed except for the warm air intake register and the cool air discharge register.

11. The evaporator air cooler of claim 10 wherein:
said cool air discharge register comprises:
at least one vertical and horizontal louver; and
at least one motor to oscillate the at least one vertical louver about its vertical access.

12. The evaporator air cooler of claim 11 wherein said controller controls the oscillation of the at least one vertical louver.

13. The evaporator air cooler of claim 11 wherein the at least one vertical louver comprises a curved horizontal profile.

14. The evaporator air cooler of claim 10 further comprising a sensor to monitor when the level of water in the water reservoir is below or above predetermined values.

15. The evaporator air cooler of claim 10 further comprising wheels mounted to the bottom panel.

16. An evaporative air cooler comprising:
a housing having a front panel, side panels, top panel and bottom panel defining an interior of the evaporative air cooler;
a warm air intake register positioned within the front panel;
a cool air discharge register positioned within the front panel;
a water reservoir formed within the bottom panel, said bottom panel having a lower portion and an upper portion;
a filter media position and supported above the water reservoir, said filter media having an intake side positioned proximate the warm air intake register and a discharge side;
a water misting system positioned above the filter media comprising a misting bar;
a pump positioned and support within the upper portion of the water reservoir, said pump having a conduit in fluid communication with water inside the water reservoir and the misting bar;
a fan generally positioned above the water misting system, said fan having an intake region generally proximate the discharge end of the filter media and a discharge region proximate the cool air discharge register;
a controller to control the speed of the fan and the amount of water being suctioned by said pump; and
sensors to monitor the level of water in the water reservoir, the ambient air temperature outside the housing and the air temperature being discharged by the fan,
wherein the interior of the evaporative air cooler is substantially sealed except for the warm air intake register and the cool air discharge register.

17. The evaporator air cooler of claim 16 wherein said controller controls the oscillation of the at least one vertical louver.

18. The evaporator air cooler of claim 17 wherein the at least one vertical louver comprises a curved horizontal profile.

19. The evaporator air cooler of claim 16 wherein said sensors further monitor when the level of water in the water reservoir is below or above predetermined values.

20. The evaporator air cooler of claim 16 further comprising wheels mounted to the bottom panel.
